(19) United States
(12) Patent Application Publication
(10) Pub. No.: US 2011/0031892 A1
(43) Pub. Date: Feb. 10, 2011

(54) LIGHTING DEVICE AND DISPLAY DEVICE

(75) Inventor: Masahiro Arai, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/936,556

(22) PCT Filed: Nov. 5, 2008
(86) PCT No.: PCT/JP2008/070119

§ 371 Date: Oct. 6, 2010

(30) Foreign Application Priority Data
Apr. 30, 2008 (JP) 2008-118592

(51) Int. Cl. H05B 41/24

(52) U.S. Cl. 315/279; 315/276

(57) ABSTRACT

A lighting device (8), which is provided with a cold cathode fluorescent tube (light source) (9) and a chassis (8a) that houses the cold cathode fluorescent tube (9), includes an inverter circuit (16) that includes a transformer (16a) to be connected to the cold cathode fluorescent tube (9) and drives the cold cathode fluorescent tube (9). The inverter circuit (16) drives the cold cathode fluorescent tube (9) using a frequency higher than a predetermined fundamental frequency during a predetermined period within a period in which the cold cathode fluorescent tube (9) is lit.

### TECHNICAL FIELD

The present invention relates to a lighting device, in particular, a lighting device using a cold cathode fluorescent tube or the like as a light source, and a display device using the same.

### BACKGROUND ART

Recently, in a household television receiver, for example, a display device provided with a liquid crystal panel as a flat display portion with a number of features such as thinness and a light weight as compared with a conventional Broun tube, as typified by a liquid crystal display device, is becoming a mainstream. Such a liquid crystal display device includes a lighting device (backlight) that emits light and a liquid crystal panel that displays a desired image by playing a role of a shutter with respect to light from a light source provided in the lighting device. The television receiver displays information such as characters and images contained in video signals of a television broadcast on a display surface of the liquid crystal panel.

Further, the above-described lighting device is classified roughly into a direct type and an edge-light type depending on the arrangement of the light source with respect to the liquid crystal panel. A liquid crystal display device provided with a liquid crystal panel of 20 inches or more generally uses the direct type lighting device that can achieve an increase in brightness and size more easily than the edge-light type lighting device. More specifically, in the direct type lighting device, a plurality of light sources are arranged on the rear side (non-display surface) of the liquid crystal panel. Since the light sources can be arranged right on the reverse side of the liquid crystal panel, it is possible to use a number of the light sources. Thus, the direct type lighting device can achieve high brightness easily and is suitable for an increase in brightness and size. Further, the direct type lighting device has a hollow structure and hence is light-weight even when enlarged. This also allows the direct type lighting device to be suitable for an increase in brightness and size.

It has been proposed, as described in JP 2002-196326 A, for example, that in the conventional direct type lighting device as described above, a plurality of cold cathode fluorescent tubes as light sources are housed in a metal chassis, and a metal reflector is provided on an inner surface of the chassis, whereby the light utilization efficiency of the cold cathode fluorescent tubes is improved.

Further, it has been proposed, as described in JP 2002-231034 A, for example, that in the conventional lighting device, an inverter circuit is connected to each of a plurality of the cold cathode fluorescent tubes so as to drive the cold cathode fluorescent tube by way of high-frequency lighting.

### DISCLOSURE OF INVENTION

### Problem to be Solved by the Invention

However, the conventional lighting device as described above may have a problem in that when the cold cathode fluorescent tube (light source) is lit with the inverter circuit, noise is generated from the vicinity of the cold cathode fluorescent tube and the inverter circuit, which then is transmitted to the outside.

Specifically, in the above-described conventional lighting device, the cold cathode fluorescent tube is supplied with electric power via a transformer provided in the inverter circuit. Namely, in this conventional lighting device, the secondary side of the transformer is connected to the cold cathode fluorescent tube, so that a current (lamp current) determined in accordance with a light emission amount required from the outside is supplied to the cold cathode fluorescent tube from the secondary side of the transformer.

However, in the conventional lighting device as described above, the transformer in the inverter circuit may create magnetostrictive vibrations, and noise resulting from the magnetostrictive vibrations may leak out.

Further, in the conventional lighting device, the reflector and the chassis made of metal are provided on a side opposite to an emission surface of the cold cathode fluorescent tube, and a leakage current is generated in the cold cathode fluorescent tube due to a parasitic capacitance present on the periphery of the cold cathode fluorescent tube, e.g., between the cold cathode fluorescent tube and each of the reflector and the chassis. Further, when such a leakage current is generated, sound waves may be produced inside the chassis depending on the magnitude of the leakage current, which causes the chassis to be vibrated, and the vibrations may leak out as noise.

In order to prevent the generation of a leakage current as described above, a reflector and a chassis made of synthetic resin may be used instead of the reflector and the chassis made of metal. However, in the case of using a reflector and a chassis made of synthetic resin, a leakage inductance in the inverter circuit that lights the cold cathode fluorescent tube has a significantly small value as compared with the case of using the reflector and the chassis made of metal, which causes a decrease in the electric power efficiency in the inverter circuit. Thus, another problem arises in that the cold cathode fluorescent tube cannot be lit efficiently.

As described above, according to the conventional lighting device, noise generated by the lighting of the cold cathode fluorescent tube with the inverter may be transmitted to the outside.

In view of the above-described problems, it is an object of the present invention to provide a lighting device that can reduce noise generated by the lighting of a light source with an inverter, and a display device using the same.

### Means for Solving Problem

In order to achieve the above-described object, a lighting device according to the present invention is provided with a light source and a chassis that houses the light source. The lighting device includes an inverter circuit that includes a transformer to be connected to the light source and drives the light source. The inverter circuit drives the light source using a frequency higher than a predetermined fundamental frequency during a predetermined period within a period in which the light source is lit.

The inventor of the present invention has found that with the lighting device configured as described above in which the inverter circuit drives the light source using a frequency higher than a predetermined fundamental frequency during a predetermined period within a period in which the light source is lit, noise generated by the lighting of the light source with the inverter can be converted into inaudible noise. That is, the inventor of the present invention has discovered that when the light source is lit with the inverter at a frequency higher than a predetermined fundamental frequency during a predetermined period within a period in which the light source is lit at the fundamental frequency, noise generated by the lighting with the inverter can be made inaudible to a user. The present invention has been accomplished based on the findings as described above, and it is possible to provide the lighting device that can reduce noise generated by the lighting of the light source with the inverter.

Further, the above-described lighting device preferably includes a control portion that receives a dimming instruction signal from the outside and determines a duty ratio of PWM dimming using the input dimming instruction signal. The control portion preferably generates a driving signal for driving the light source based on the determined duty ratio and outputs the same to the inverter circuit.

In this case, even when the control portion subjects the light source to the dimming control in PWM dimming, it is possible to prevent the generation of noise reliably.

Further, in the above-described lighting device, the inverter circuit preferably drives the light source using a frequency not less than double the fundamental frequency during the predetermined period.

In this case, it is possible to prevent the generation of noise more reliably.

Further, in the above-described lighting device, the light source may be a cold cathode fluorescent tube.

In this case, it is possible to provide the lighting device that is compact and excellent in light-emission efficiency easily.

Further, a display device of the present invention uses any of the above-described lighting devices.

Since the display device configured as described above uses the lighting device that can reduce noise generated by the lighting of the light source with the inverter, it is possible to provide easily the low-noise display device in which the generation of noise is prevented.

### Effects of the Invention

According to the present invention, it is possible to provide a lighting device that can reduce noise generated by the lighting of a light source with an inverter, and a display device using the same.

### BRIEF DESCRIPTION OF DRAWINGS

FIG. 1 is an exploded perspective view illustrating a television receiver and a liquid crystal display device according to an embodiment of the present invention.

FIG. 2 is a view illustrating a configuration of main portions of the liquid crystal display device.

FIG. 3 is a view illustrating a configuration of main portions of a lighting device shown in FIG. 2.

FIG. 4 is a view illustrating an exemplary configuration of an inverter circuit shown in FIG. 3.

FIG. 5 is a block diagram showing a specific configuration of a lighting control portion shown in FIG. 2.

FIG. 6 is a waveform diagram showing a specific waveform of a current to be supplied from the inverter circuit to a cold cathode fluorescent tube.

### DESCRIPTION OF THE INVENTION

Hereinafter, a preferred embodiment of a lighting device and a display device using the same according to the present invention will be described with reference to the drawings. It should be noted that the following description is directed to the case where the present invention is applied to a transmission type liquid crystal display device by way of example. Further, the size and size ratio of the constituent members in each figure do not exactly reflect those of actual constituent members.

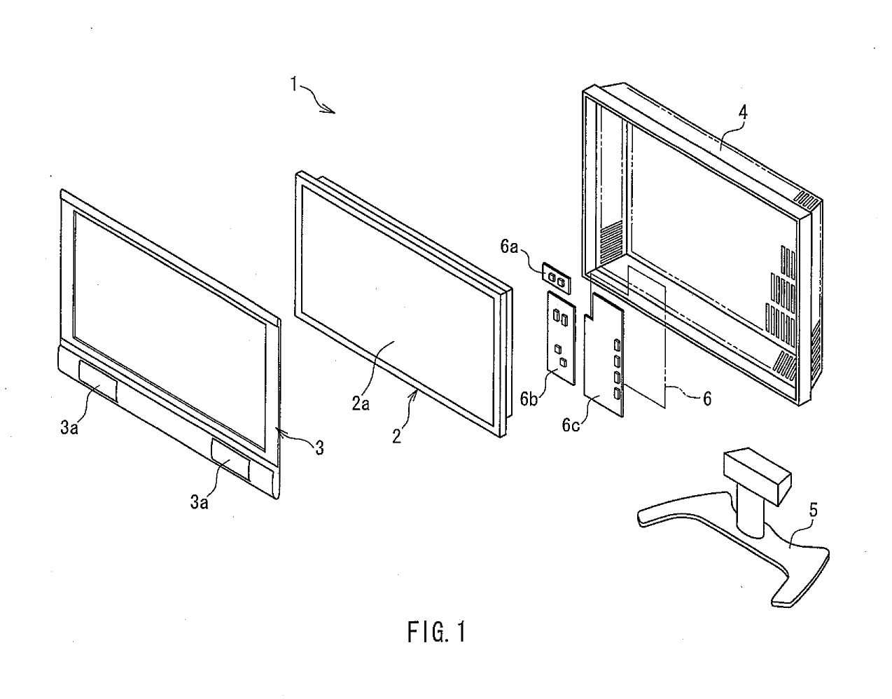

FIG. 1 is an exploded perspective view illustrating a television receiver and a liquid crystal display device according to an embodiment of the present invention. In the figure, a television receiver 1 of the present embodiment is provided with a liquid crystal display device 2 as a display device and is configured to be capable of receiving a television broadcast by means of an antenna, a cable (not shown), and the like. The liquid crystal display device 2, housed within a front cabinet 3 and a back cabinet 4, is set upright by using a stand 5. Further, in the television receiver 1, a display surface 2a of the liquid crystal display device 2 is configured to be visible via the front cabinet 3. The liquid crystal display device 2 is supported by the stand 5 in such a manner that this display surface 2a is parallel to the direction of gravity (vertical direction).

Further, in the television receiver 1, between the liquid crystal display device 2 and the back cabinet 4, there also are provided a TV tuner circuit board 6a, a control circuit board 6b for controlling each portion of the television receiver 1, such as a lighting device to be described later, and a power supply circuit board 6c, which are mounted on a support plate 6. Further, in the television receiver 1, images corresponding to video signals of a television broadcast received by a TV tuner on the TV tuner circuit board 6a are displayed on the display surface 2a, while audio is reproduced and output from speakers 3a mounted on the front cabinet 3. It should be noted that a number of air holes are formed on the back cabinet 4 so as to appropriately release heat generated in the lighting device, a power source, and the like.

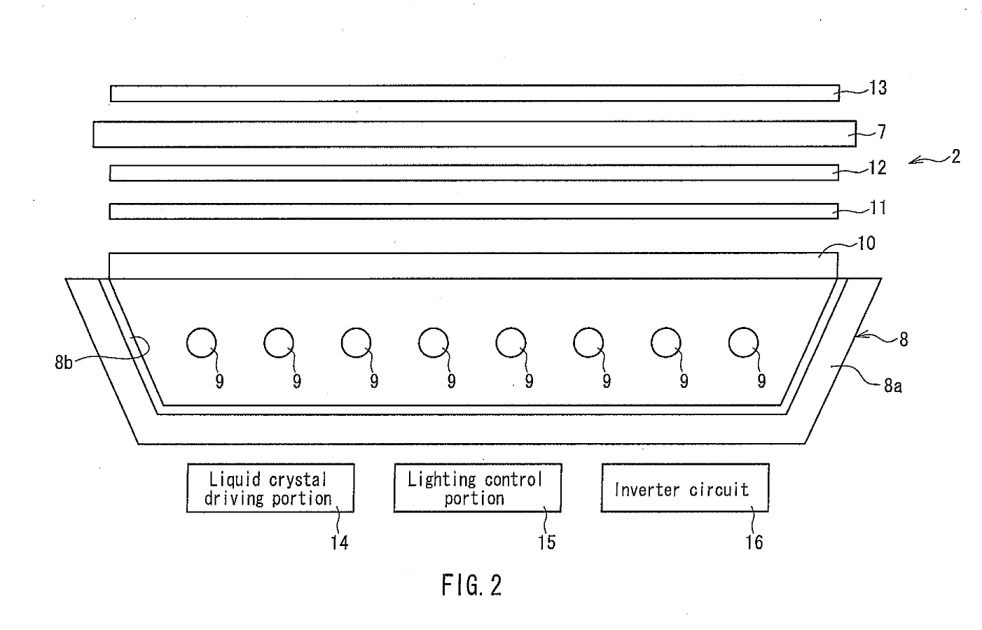

Next, the liquid crystal display device 2 will be described specifically with reference to FIG. 2.

FIG. 2 is a view illustrating a configuration of main portions of the liquid crystal display device. In the figure, the liquid crystal display device 2 includes a liquid crystal panel 7 and a lighting device 8 of the present invention. The liquid crystal panel 7, as a display portion, displays information such as characters and images. The lighting device 8 is disposed on a non-display surface side (lower side of the figure) of the liquid crystal panel 7 and generates illumination light to illuminate the liquid crystal panel 7. The liquid crystal panel 7 and the lighting device 8 are integrated so as to form the liquid crystal display device 2 of a transmission type. In the liquid crystal display device 2, a pair of polarizing plates 12 and 13 are disposed on the non-display surface side and the display surface side of the liquid crystal panel 7, respectively, in such a manner that transmission axes thereof are arranged in crossed-Nicols.

The lighting device 8 includes a bottomed chassis 8a and a plurality of cold cathode fluorescent tubes (CCFLs) 9 housed in the chassis 8a at equal intervals. On an inner surface of the chassis 8a, there is provided, for example, a reflection sheet 8b that reflects light from the cold cathode fluorescent tubes 9 as light sources to the liquid crystal panel 7 side, thereby improving the light utilization efficiency of the cold cathode fluorescent tubes 9.

Each of the cold cathode fluorescent tubes 9 is of a straight-tube type, and electrode portions (not shown) provided at both ends thereof are supported on an outer side of the chassis 8a. Further, each of the cold cathode fluorescent tubes 9 also is configured to have a small diameter of about 3.0 to 4.0 mm so as to have excellent light-emission efficiency, which facilitates the configuration of the lighting device 8 that is compact and excellent in light-emission efficiency. Each of the cold cathode fluorescent tubes 9 is held on an inner side of the chassis 8a with a light source holder (not shown) while distances from each of the cold cathode fluorescent tubes 9 to a diffusion plate 10 and to the reflection sheet 8b are kept at predetermined distances.

Further, a plurality of the cold cathode fluorescent tubes 9 are arranged so that the longitudinal direction thereof is parallel to a direction perpendicular to the direction of gravity. This arrangement can prevent mercury (vapor) sealed in each of the cold cathode fluorescent tubes 9 from being concentrated at one end of the cold cathode fluorescent tube 9 in the longitudinal direction due to the action of gravity, resulting in significantly improved lamp life.

On the outer side of the chassis 8a, there are provided a liquid crystal driving portion 14 that drives the liquid crystal panel 7, a lighting control portion 15 as a control portion for the lighting device 8, and an inverter circuit 16 that drives each of a plurality of the cold cathode fluorescent tubes 9 by way of high-frequency lighting using a control signal from the lighting control portion 15. The liquid crystal driving portion 14, the lighting control portion 15, and the inverter circuit 16 are mounted on the control circuit board 6b (FIG. 1) and disposed so as to be opposed to the outer side of the chassis 8a.

Further, the lighting device 8 includes the diffusion plate 10 that is disposed so as to cover an opening of the chassis 8a, and an optical sheet 11 that is disposed above the diffusion plate 10. The diffusion plate 10 is made of, for example, a rectangular-shaped synthetic resin or glass material having a thickness of about 2 mm. The diffusion plate 10 is held movable on the chassis 8a, so that even when elastic (plastic) deformation occurs on the diffusion plate 10 under the influence of heat, caused by heat generation of the cold cathode fluorescent tubes 9, temperature rise inside the chassis 8a, and the like, the diffusion plate 10 can absorb such deformation by moving on the chassis 8a.

The optical sheet 11 includes a diffusion sheet formed of, for example, a synthetic resin film having a thickness of about 0.2 mm and is configured to improve the display quality on the display surface of the liquid crystal panel 7 by diffusing the illumination light toward the liquid crystal panel 7 appropriately. Further, on the optical sheet 11, commonly-known optical sheet materials such as a prism sheet and a polarization reflecting sheet are laminated suitably as required for the purpose of, for example, improving the display quality on the display surface of the liquid crystal panel 7. The optical sheet 11 is configured to convert plane-shaped light output from the diffusion plate 10 into plane-shaped light having an almost uniform brightness not lower than a predetermined brightness (e.g., 10000 cd/m²) and make it incident on the liquid crystal panel 7 as illumination light.

Besides the configuration as described above, for example, optical members such as a diffusion sheet for adjusting a viewing angle of the liquid crystal panel 7 may be laminated suitably above the liquid crystal panel 7 (on the display surface side).

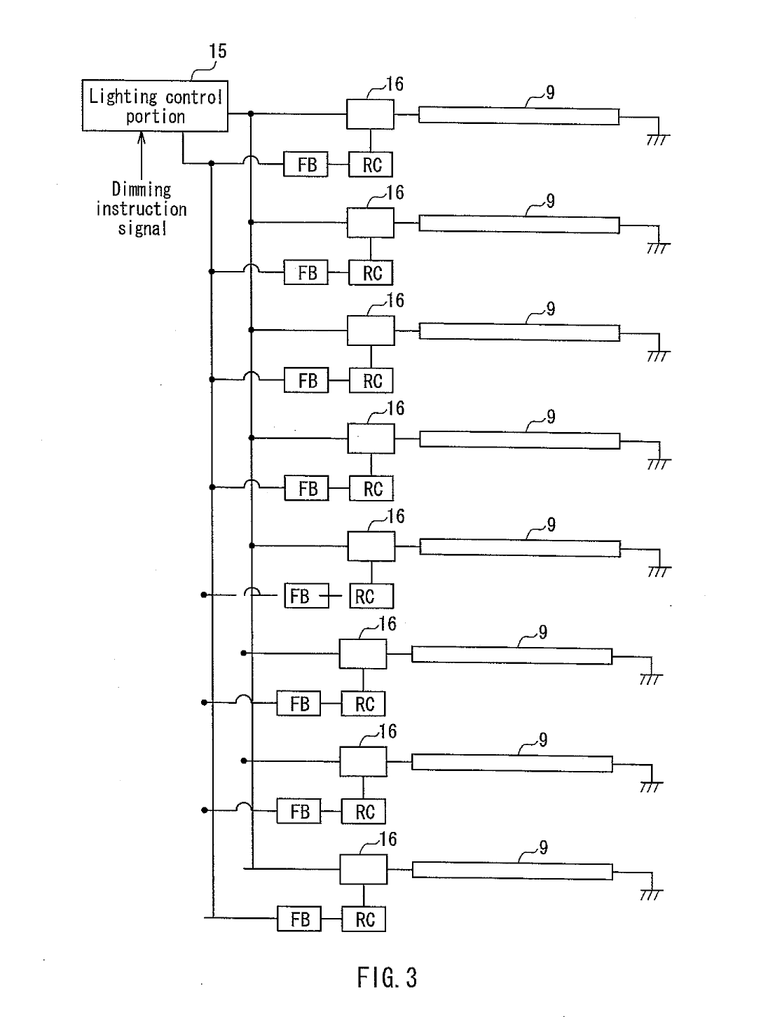

Now, the lighting device 8 of the present embodiment will be described specifically also with reference to FIGS. 3 to 5.

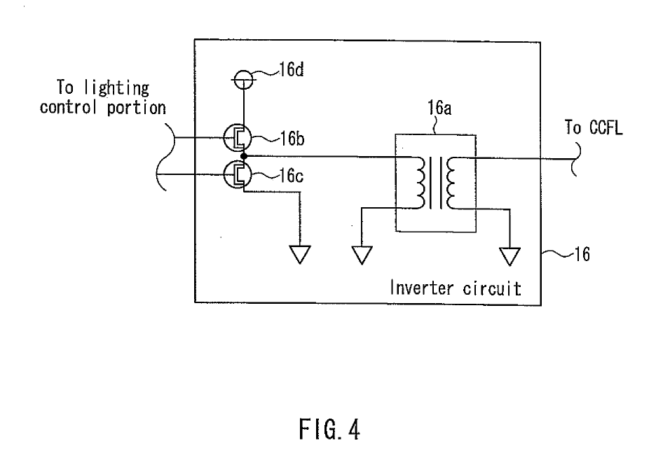

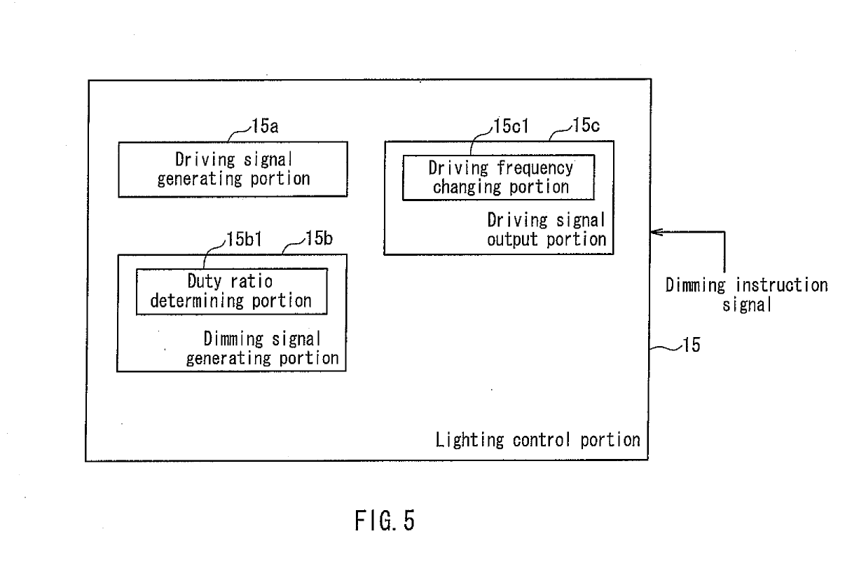

FIG. 3 is a view illustrating a configuration of main portions of the lighting device shown in FIG. 2. FIG. 4 is a view illustrating an exemplary configuration of the inverter circuit shown in FIG. 3. FIG. 5 is a block diagram showing a specific configuration of the lighting control portion shown in FIG. 2.

As shown in FIG. 3, the lighting device 8 includes the lighting control portion 15 for controlling the driving of each of a plurality of the cold cathode fluorescent tubes 9, and the inverter circuit 16 as a CCFL driving circuit that is provided for each of the cold cathode fluorescent tubes 9 and lights the corresponding cold cathode fluorescent tube 9 based on the control signal (driving signal) from the lighting control portion 15. The inverter circuit 16 is disposed on one end side of each of the cold cathode fluorescent tubes 9 in the longitudinal direction so as to supply a current to the corresponding cold cathode fluorescent tube 9 from the one end side.

Further, the inverter circuit 16 is of, for example, a half-bridge type as will be described in detail later and is configured to be capable of driving the corresponding cold cathode fluorescent tube 9 by using PWM dimming based on the driving signal.

In the lighting device 8, a specific frequency of the PWM dimming has a value (e.g., 500 Hz) in a range of about 100 to 600 Hz. Further, in an ON period of the PWM dimming, a current (lamp current) to be supplied to each of the cold cathode fluorescent tubes 9, i.e., a specific operating frequency of each of the cold cathode fluorescent tubes 9 (driving frequency of the light source), has a value (e.g., 33.5 KHz) in a range of about 30 to 60 KHz as a fundamental frequency in a period in which the cold cathode fluorescent tube 9 is lit.

The inverter circuit 16 drives the cold cathode fluorescent tube 9 using a frequency higher than the fundamental frequency during a predetermined period within a period in which the cold cathode fluorescent tube 9 is lit using the fundamental frequency (details will be described later).

Further, the lighting device 8 includes a lamp current detection circuit RC that is provided for each of the inverter circuits 16 (cold cathode fluorescent tubes 9) and detects the value of a lamp current flowing through the corresponding cold cathode fluorescent tube 9. In the lighting device 8, the lamp current value detected by each of the lamp current detection circuits RC is output to the lighting control portion 15 through a feedback circuit FB that is provided so as to correspond to each of the cold cathode fluorescent tubes 9.

Further, the lighting control portion 15 receives as an instruction signal from the outside, for example, a dimming instruction signal for changing the brightness on the emission surface of the lighting device 8, so that a user is allowed to change the brightness (lightness) on the display surface of the liquid crystal panel 7 in the liquid crystal display device 2 suitably. More specifically, the lighting control portion 15 is configured to receive the dimming instruction signal from an operation input device (not shown) such as a remote controller provided on the liquid crystal display device 2 side, for example. Then, the lighting control portion 15 determines a duty ratio of the PWM dimming using the input dimming instruction signal and determines a target value of the current to be supplied to each of the cold cathode fluorescent tubes 9.

Thereafter, the lighting control portion 15 generates and outputs a driving signal for each of the inverter circuits 16 based on the determined target value, thereby changing the value of the lamp current flowing through the corresponding cold cathode fluorescent tube 9. As a result, the amount of light to be emitted from each of the cold cathode fluorescent tubes 9 is changed in accordance with the dimming instruction signal, so that the brightness on the emission surface of the lighting device 8 and the brightness on the display surface of the liquid crystal panel 7 are changed appropriately in accordance with a user's operation instruction.

The value of the lamp current actually supplied to each of the cold cathode fluorescent tubes 9 is fed back to the lighting control portion 15 as a detected current value via the corresponding lamp current detection circuit RC and feedback control circuit FB. Then, in the lighting control portion 15, the feedback control is performed using the detected current value and the target value of the supply current determined based on the dimming instruction signal, whereby a display is maintained at a user's desired brightness.

As shown in FIG. 4 by way of example, the inverter circuit 16 is of a half-bridge type that includes a transformer 16a, first and second switching members 16b and 16c that are connected to the lighting control portion 15 and are provided in series on a primary winding side of the transformer 16a, and a driving power source 16d connected to the first switching 16b.

The first and second switching members 16b and 16c are field effect transistors (FETs), for example, and receive as the driving signals first and second driving signals, respectively, that are 180° out of phase with each other from the lighting control portion 15, thereby controlling ON/OFF of power supply to the cold cathode fluorescent tube 9 connected to a secondary winding side of the transformer 16a, which will be described in detail later.

The inverter circuit 16 lights the corresponding cold cathode fluorescent tube 9 (FIG. 3) at a high frequency. More specifically, the secondary winding of the transformer 16a is connected with a high-voltage side terminal of any of the cold cathode fluorescent tubes 9, and when the first and second switching members 16b and 16c perform a switching operation based on the first and second driving signals from the lighting control portion 15, the transformer 16a supplies electric power to the corresponding cold cathode fluorescent tube 9 and lights the same. Further, the secondary winding of the transformer 16a is connected with the lamp current detection circuit RC, so that the lamp current value in the corresponding cold cathode fluorescent tube 9 is detected.

Further, as shown in FIG. 5, the lighting control portion 15 includes a driving signal generating portion 15a, a dimming signal generating portion 15b, and a driving signal output portion 15c, and generates and outputs the driving signal for the inverter circuit 16 connected to each of the cold cathode fluorescent tubes 9 based on the dimming instruction signal. The respective portions of the lighting control portion 15 are ICs, LSIs, or the like, for example, and the lighting control portion 15 determines the duty ratio of the PWM dimming based on the dimming instruction signal from the outside and generates the driving signal, thereby lighting each of the cold cathode fluorescent tubes 9 with the inverter.

Specifically, in the lighting control portion 15, the driving signal generating portion 15a, which generates the driving signal for driving each of the cold cathode fluorescent tubes (light sources) 9, generates a predetermined driving signal of 33.5 KHz, for example, and outputs the same to the driving signal output portion 15c as described above. The driving signal generating portion 15a can be a clock signal generating portion of an IC, an LSI, or the like included in the lighting control portion 15.

The dimming signal generating portion 15b includes a duty ratio determining portion 15b1 that determines the duty ratio between an ON period and an OFF period in a PWM cycle of the PWM dimming for each of the cold cathode fluorescent tubes 9 by using the dimming instruction signal (instruction signal) from the outside. Based on the determined duty ratio, the dimming signal generating portion 15b generates a dimming signal having a dimming frequency of 500 Hz as described above, for example, and outputs the same to the driving signal output portion 15c.

In accordance with the dimming signal from the dimming signal generating portion 15b, the driving signal output portion 15c outputs the driving signal from the driving signal generating portion 15a to each of the inverter circuits 16 during the ON period based on the determined duty ratio. The driving signal output portion 15c includes a driving frequency changing portion 15c1 that changes the frequency of the driving signal for each of the inverter circuits 16. More specifically, the driving frequency changing portion 15c1 is configured to change the frequency of the driving signal based on setting instruction information that has been set previously in a memory (not shown) provided in the lighting control portion 15 at the time of factory shipment, for example. Specifically, the driving frequency changing portion 15c1 changes the frequency of the driving signal for each of the inverter circuits 16 so that each of the cold cathode fluorescent tubes 9 is lit at a frequency (i.e., 67.0 KHz) double a fundamental frequency of 33.5 KHz as described above, for example, during a predetermined period within the period in which each of the cold cathode fluorescent tubes 9 is lit at the fundamental frequency.

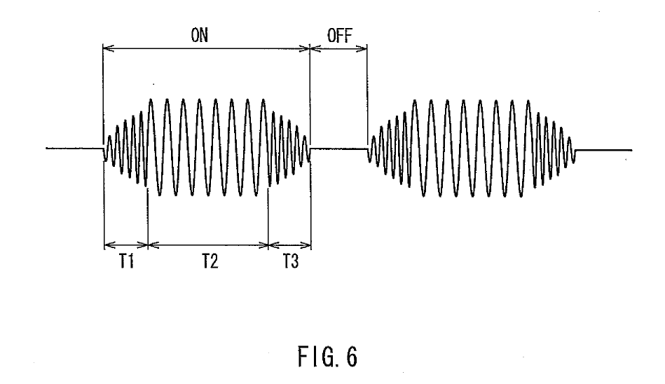

Hereinafter, an operation of the liquid crystal display device 2 of the present embodiment configured as described above will be described specifically also with reference to FIG. 6. The following description mainly explains a lighting operation of each of the cold cathode fluorescent tubes 9 in the lighting device 8.

FIG. 6 is a waveform diagram showing a specific waveform of a current to be supplied from each of the inverter circuits to the cold cathode fluorescent tube.

As shown in FIG. 6, in the lighting device 8 of the present embodiment, each of the inverter circuits 16 supplies a current to the cold cathode fluorescent tube 9 during the ON period of the PWM dimming in accordance with the driving signal from the driving signal output portion 15c. Further, the inverter circuit 16 drives the cold cathode fluorescent tube 9 using a frequency double the fundamental frequency during a predetermined period within the period in which the cold cathode fluorescent tube 9 is ON (lit).

Specifically, based on the setting instruction information, the driving signal output portion 15c changes the frequency of the driving signal so that each of the cold cathode fluorescent tubes 9 is lit with the inverter at a frequency double the fundamental frequency during a rise period T1 at the beginning of lighting and a fall period T3 before the end of lighting within the period in which the cold cathode fluorescent tube 9 is lit. As a result, as shown in FIG. 6, each of the cold cathode fluorescent tubes 9 is supplied with a current by the inverter circuit 16 at a frequency double the fundamental frequency during the rise period T1 and the fall period T3, while it is supplied with a current at the fundamental frequency during a period T2 between the rise period T1 and the fall period T3.

It should be noted that each of the rise period T1 and the fall period T3 is set to be 1/10 of the ON period (lighting period), for example. The value of each of the periods T1 and T3 can be changed suitably depending on the value of the increased frequency, the value of the ON time, or the like.

Further, the setting instruction information, which has been determined based on the results of a test or simulation using the lighting device 8 as an actual product, gives instructions for setting a specific frequency (e.g., 67.0 KHz as described above) increased to be higher than the fundamental frequency and a time of each of the periods T1 and T3 during which the increased frequency is used. The setting instruction information has been stored previously in the memory at the time of shipment of the lighting device 8.

Herein, a specific description will be given of the results of a verification test conducted by the inventor of the present application.

In the verification test, the product of the present embodiment, i.e., a lighting device including eight cold cathode fluorescent tubes 9 in which each of the cold cathode fluorescent tubes was lit with the inverter at a frequency double the predetermined fundamental frequency during the rise period and the fall period within the period in which the cold cathode fluorescent tube was lit (ON) as shown in FIG. 6, was prepared. Further, for comparison with the product of the present embodiment, a comparative product, i.e., a lighting device having the same configuration as the product of the present embodiment in which each of the cold cathode fluorescent tubes was lit with the inverter at the predetermined fundamental frequency during the same lighting period, was prepared. In the verification test, the frequency of noise generated from each of the product of the present embodiment and the comparative product was analyzed with an FFT (Fast Fourier Transformer) analyzer. An example of the results of the verification is shown in Table 1.

TABLE 1

| Product of the present embodiment | | Comparative product | |
|---|---|---|---|
| Frequency (Hz) | Noise (dBA) | Frequency (Hz) | Noise (dBA) |
| 440 | 18.91 | 440 | 19.09 |
| 880 | 22.94 | 880 | 25.76 |
| 1310 | 0.0 | 1310 | 9.54 |
| 2190 | 0.0 | 2190 | 8.54 |
| 3510 | 0.0 | 3510 | 4.93 |

As is apparent from Table 1, it was shown that the level of audible noise from the product of the present embodiment was reduced greatly as compared with the comparative product. In other words, it was confirmed that in the product of the present embodiment, when the cold cathode fluorescent tubes were lit with the inverters, noise generated by the lighting with the inverters was prevented from being transmitted to the outside, unlike the comparative product.

This is thought to be because when the driving frequency of the cold cathode fluorescent tubes is doubled, vibrations created by a leakage current or magnetostrictive vibrations of the transformers are double what they are when the cold cathode fluorescent tubes are driven at the fundamental frequency between the cold cathode fluorescent tubes and the chassis, whereby noise is prevented from leaking out of the lighting device.

In the lighting device 8 of the present embodiment configured as described above, the inverter circuits 16 drive the cold cathode fluorescent tubes 9 using a frequency double the predetermined fundamental frequency during the predetermined period within the period in which the cold cathode fluorescent tubes (light sources) are lit. Thus, the lighting device 8 of the present embodiment can reduce noise generated by the lighting of the cold cathode fluorescent tubes 9 with the inverters.

Further, in the lighting device 8 of the present embodiment, the lighting control portion 15 determines the duty ratio of the PWM dimming using the dimming instruction signal from the outside, and generates the driving signal for driving the cold cathode fluorescent tubes 9 based on the determined duty ratio and outputs the same to the inverter circuits 16. Thus, even when the lighting control portion 15 subjects the cold cathode fluorescent tubes 9 to the dimming control in the PWM dimming, the lighting device 8 of the present embodiment can prevent the generation of noise reliably.

Further, since the liquid crystal display device 2 of the present embodiment uses the lighting device 8 that can reduce noise generated by the lighting of the cold cathode fluorescent tubes 9 with the inverters, it is possible to provide easily the low-noise liquid crystal display device 2 in which the generation of noise is prevented.

It should be noted that the above-described embodiment is illustrative and not limiting. The technical scope of the present invention is specified by the scope of the claims, and any modification falling in the scope of the configuration and equivalent described therein also fall in the technical scope of the present invention.

For example, although the above description explains the case where the present invention is applied to the transmission type liquid crystal display device, the lighting device of the present invention is not limited thereto. The lighting device of the present invention may be applied to various types of display devices each of which has a non-light-emitting type display portion for displaying information such as images and characters by utilizing light from a light source. Specifically, the lighting device of the present invention can be applied suitably to a semi-transmission type liquid crystal display device or to a projection type display device in which a liquid crystal panel is used as a light bulb.

Further, besides the above description, the present invention can be used suitably as a film viewer that irradiates light to a radiograph, a light box for irradiating light to a picture negative or the like to make it easy to recognize the negative visually, and a lighting device of a light-emitting device that lights up a signboard, an advertisement set on a wall surface in a station, or the like.

Further, although the above description explains the case where the cold cathode fluorescent tube is used, the light source of the present invention is not limited thereto. Another discharge fluorescent tube such as a hot cathode fluorescent tube and a xenon fluorescent tube, or a non-straight-tube discharge fluorescent tube such as a U-shaped tube and a pseudo U-shaped tube may be used.

Namely, the type and number of the light source, the driving method for the light source, the configuration of the inverter circuit, or the like is not limited in anyway to that described above, as long as the present invention includes the transformer to be connected to the light source and the inverter circuit that drives the light source using a frequency higher than a predetermined fundamental frequency during a predetermined period within a period in which the light source is lit.

Specifically, although the above description explains the case where the half-bridge type inverter circuit is used, the present invention may be applied to a full-bridge type inverter circuit that has four switching members, for example. Further, in the case of using a discharge fluorescent tube that does not contain mercury, such as a xenon fluorescent tube as described above, it is possible to provide a long-life lighting device in which the discharge tubes are arranged in parallel with the direction of gravity.

Further, the above description explains the case where the cold cathode fluorescent tube (light source) is driven using a frequency higher than the predetermined fundamental frequency during the rise period and the fall period within the period in which the cold cathode fluorescent tube is lit as shown in FIG. 6. However, the present invention is not limited thereto, and the light source may be driven at a frequency higher than the fundamental frequency during a period either just after the beginning of lighting (rise period) or just before the end of lighting (fall time), or during a predetermined period within the lighting period after a predetermined time has elapsed since the beginning of lighting.

However, it is preferred that, as in the above-described embodiment, the inverter circuit drives the light source using a frequency not less than double the fundamental frequency during a predetermined period, because this makes it possible to prevent the generation of noise more reliably.

Further, the above description explains the case where the inverter circuit is disposed on the one end side of the cold cathode fluorescent tube in the longitudinal direction so as to supply a current to the cold cathode fluorescent tube from the one end side. However, the present invention is not limited thereto, and the inverter circuit may be disposed on each of the one end side and the other end side of the cold cathode fluorescent tube in the longitudinal direction so as to supply a current to the cold cathode fluorescent tube from both the one end side and the other end side.

### INDUSTRIAL APPLICABILITY

The present invention is useful for a lighting device that can reduce noise generated by the lighting of a light source with an inverter, and a display device using the same.

1. A lighting device provided with a light source and a chassis that houses the light source, the lighting device comprising:
an inverter circuit that includes a transformer to be connected to the light source and drives the light source,
wherein the inverter circuit drives the light source using a frequency higher than a predetermined fundamental frequency during a predetermined period within a period in which the light source is lit.

2. The lighting device according to claim 1, comprising a control portion that receives a dimming instruction signal from the outside and determines a duty ratio of PWM dimming using the input dimming instruction signal,
wherein the control portion generates a driving signal for driving the light source based on the determined duty ratio and outputs the same to the inverter circuit.

3. The lighting device according to claim 1, wherein the inverter circuit drives the light source using a frequency not less than double the fundamental frequency during the predetermined period.

4. The lighting device according to claim 1, wherein the light source is a cold cathode fluorescent tube.

5. A display device using the lighting device according to claim 1.
